(19) United States
(12) Patent Application Publication
(10) Pub. No.: US 2026/0311420 A1
(43) Pub. Date: Oct. 8, 2026

(54) HAIR PROCESSING METHOD AND APPARATUS, AND ELECTRONIC DEVICE AND STORAGE MEDIUM

(71) Applicant: Beijing Zitiao Network Technology Co., Ltd., Beijing (CN)

(72) Inventors: Weijie XI, Beijing (CN); Xuanmeng XIE, Beijing (CN)

(21) Appl. No.: 19/472,619

(22) PCT Filed: Apr. 2, 2024
(86) PCT No.: PCT/CN2024/085495

§ 371 Date: Oct. 3, 2025

(30) Foreign Application Priority Data
Apr. 12, 2023 (CN) 202310397317.2

(51) Int. Cl. G06T 15/20; G06T 7/246; G06T 7/73; G06T 13/40

(52) U.S. Cl. CPC G06T 15/205; G06T 7/246; G06T 7/73; G06T 13/40; G06T 2207/30196

(57) ABSTRACT

Embodiments of the present disclosure provide a hair processing method and apparatus, and an electronic device and a storage medium. The method includes: obtaining hair strand data, and classifying the hair strand data into a guide hair strand and a regular hair strand; processing the guide hair strand based on an initial pose of the guide hair strand to obtain a simulated pose of the guide hair strand; obtaining motion information of the guide hair strand based on the simulated pose and the initial pose of the guide hair strand, where the motion information represents a posture change feature of the simulated pose of the guide hair strand relative to the initial pose of the guide hair strand; and obtaining a rendered hair strand image based on the motion information and an initial pose of the regular hair strand.

### CROSS-REFERENCE TO RELATED APPLICATIONS

The present application is based on and claims priority to Chinese Patent Application No. 202310397317.2, filed on Apr. 12, 2023, the disclosure of which is incorporated herein by reference in its entirety.

### TECHNICAL FIELD

Embodiments of the present disclosure relate to the technical field of image processing, and in particular, to a hair processing method and apparatus, and an electronic device and a storage medium.

### BACKGROUND

Currently, in the fields of short video generation, game production, and the like, in pursuit of more realistic visual effects, the hair of a person or an animal is dynamically simulated at the strand level, so as to exhibit vivid visual effects. In this process, the motion states of hair strands need to be simulated based on hair strand data to obtain the simulated poses of the hair strands in the next frame of image. Then, rendering is further performed based on the simulated poses to implement motion of the hair strands.

However, since the hair strand data covers a huge number of hair strands, it is difficult to simulate each hair strand independently while meeting the requirements of real-time rendering. Therefore, in the related art, the solutions typically simulate only the guide hair strands in the hair strand data, and then apply the simulated poses of the guide hair strands to other regular hair strands, thereby implementing simulation of all the hair strands.

### SUMMARY

Embodiments of the present disclosure provide a hair processing method and apparatus, and an electronic device and a storage medium.

According to a first aspect, an embodiment of the present disclosure provides a hair strand processing method. The method includes:
obtaining hair strand data, and classifying the hair strand data into a guide hair strand and a regular hair strand;
processing the guide hair strand based on an initial pose of the guide hair strand to obtain a simulated pose of the guide hair strand; obtaining motion information of the guide hair strand based on the simulated pose and the initial pose of the guide hair strand, wherein the motion information represents a posture change feature of the simulated pose of the guide hair strand relative to the initial pose of the guide hair strand; and obtaining a rendered hair strand image based on the motion information and an initial pose of the regular hair strand.

According to a second aspect, an embodiment of the present disclosure provides a hair strand processing apparatus. The apparatus includes:
an obtaining module configured to obtain hair strand data, and classify the hair strand data into a guide hair strand and a regular hair strand;
a simulation module configured to process the guide hair strand based on an initial pose of the guide hair strand to obtain a simulated pose of the guide hair strand;
a processing module configured to obtain motion information of the guide hair strand based on the simulated pose and the initial pose of the guide hair strand, wherein the motion information represents a posture change feature of the simulated pose of the guide hair strand relative to the initial pose of the guide hair strand; and
a rendering module configured to obtain a rendered hair strand image based on the motion information and an initial pose of the regular hair strand.

According to a third aspect, an embodiment of the present disclosure provides an electronic device. The electronic device includes:
a processor and a memory communicatively connected to the processor, wherein
the memory stores computer-executable instructions; and
the processor executes the computer-executable instructions stored in the memory, to implement the hair strand processing method according to the first aspect and various possible designs of the first aspect.

According to a fourth aspect, an embodiment of the present disclosure provides a computer-readable storage medium. The computer-readable storage medium stores computer-executable instructions that, when executed by a processor, cause the hair strand processing method according to the first aspect and various possible designs of the first aspect to be implemented.

According to a fifth aspect, an embodiment of the present disclosure provides a computer program product including a computer program that, when executed by a processor, causes the hair strand processing method according to the first aspect and various possible designs of the first aspect to be implemented.

According to the hair processing method and apparatus, and the electronic device and the storage medium provided in the embodiments, hair strand data is obtained, wherein the hair strand data is used to represent an initial pose of a guide hair strand and an initial pose of a regular hair strand corresponding to the guide hair strand; the guide hair strand is simulated based on the hair strand data to obtain a simulated pose of the guide hair strand; motion information of the guide hair strand is obtained based on the simulated pose and the initial pose of the guide hair strand, wherein the motion information represents a posture change feature of the simulated pose of the guide hair strand relative to the initial pose of the guide hair strand; and a rendered hair strand image is obtained based on the motion information and the initial pose of the regular hair strand. Through the simulated pose of the guide hair strand, the motion information representing the pose change feature of the guide hair strand is obtained. In addition, the motion information is used as a pose change amount to redirect the regular hair strand, so that a corresponding simulation result is obtained for the regular hair strand on the basis of the original initial pose in combination with the motion information, thereby obtaining the rendered hair strand image.

### BRIEF DESCRIPTION OF THE DRAWINGS

In order to more clearly describe the technical solutions in the embodiments of the present disclosure or in the related art, the accompanying drawings for describing the embodiments or the related art will be briefly described below. Apparently, the accompanying drawings in the description below show some embodiments of the present disclosure, and those of ordinary skill in the art may still derive other accompanying drawings from these accompanying drawings without creative efforts.

FIG. 1 is a diagram of an application scenario of a hair strand processing method according to an embodiment of the present disclosure;

FIG. 2 is a first schematic flowchart of a hair strand processing method according to an embodiment of the present disclosure;

FIG. 3 is a schematic diagram of poses of hair strands according to an embodiment of the present disclosure;

FIG. 4 is a schematic diagram of poses of a guide hair strand and regular hair strands according to an embodiment of the present disclosure;

FIG. 5 is a flowchart of a specific implementation of step S102 in the embodiment shown in FIG. 2;

FIG. 6 is a schematic diagram of particle motion states of hair strand particles according to an embodiment of the present disclosure;

FIG. 7 is a flowchart of a specific implementation of step S103 in the embodiment shown in FIG. 2;

FIG. 8 is a schematic diagram of a process of generating a simulated pose of a regular hair strand according to an embodiment of the present disclosure;

FIG. 9 is a second schematic flowchart of a hair strand processing method according to an embodiment of the present disclosure;

FIG. 10 is a flowchart of a specific implementation of step S203 in the embodiment shown in FIG. 9;

FIG. 11 is a flowchart of another specific implementation of step S203 in the embodiment shown in FIG. 9;

FIG. 12 is a schematic diagram of a virtual hair strand particle according to an embodiment of the present disclosure;

FIG. 13 is a schematic diagram of generating weighted motion information according to an embodiment of the present disclosure;

FIG. 14 is a flowchart of a specific implementation of step S208 in the embodiment shown in FIG. 9;

FIG. 15 is a block diagram of a structure of a hair strand processing apparatus according to an embodiment of the present disclosure;

FIG. 16 is a schematic diagram of a structure of an electronic device according to an embodiment of the present disclosure; and

FIG. 17 is a schematic diagram of a hardware structure of an electronic device according to an embodiment of the present disclosure.

### DETAILED DESCRIPTION

In order to make the objectives, technical solutions, and advantages of embodiments of the present disclosure clearer, the technical solutions in the embodiments of the present disclosure will be described clearly and completely below with reference to the accompanying drawings in the embodiments of the present disclosure. Apparently, the embodiments described are some rather than all of the embodiments of the present disclosure. All other embodiments obtained by those of ordinary skill in the art based on the embodiments of the present disclosure without any creative effort shall fall within the scope of protection of the present disclosure.

It should be noted that user information (including but not limited to device information, personal information, etc., of a user) and data (including but not limited to data for analysis, stored data, displayed data, etc.) involved in the present disclosure are information and data for which an authorization is obtained from the user or a full authorization is obtained from each party, and the collection, use, and processing of relevant data need to comply with relevant laws, regulations, and standards of relevant countries and regions, for which corresponding operation entries are provided for the user to choose to authorize or deny.

An application scenario of the embodiments of the present disclosure is described below.

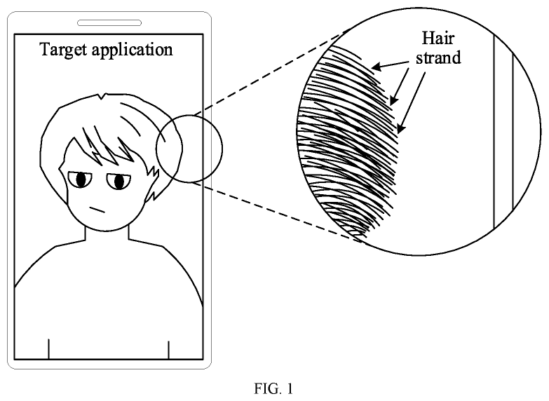

FIG. 1 is a diagram of an application scenario of a hair strand processing method according to an embodiment of the present disclosure. The hair strand processing method according to this embodiment of the present disclosure may be applied to application scenarios such as video special effects generation and real-time game rendering. More specifically, it may be applied to an application scenario of real-time rendering of video special effects. As shown in FIG. 1, the method according to this embodiment of the present disclosure may be applied to a terminal device, for example, a smartphone or a personal computer. A smartphone is used as an example in FIG. 1 for description. The terminal device runs a target application that needs to perform hair strand special effect rendering, for example, a game application or a short video application. When the target application running in the terminal device needs to dynamically display hair strands of a person or an animal (that is, the poses of the hair strands change with the pose of the person or the animal), the terminal device dynamically renders each hair strand. For example, for the hair of a portrait shown in FIG. 1, each hair strand constituting the hair is dynamically simulated and rendered based on the hair strand processing method according to this embodiment of the present disclosure, thereby achieving the purpose of dynamically displaying hair strands of a person or an animal within an image display interface of the target application.

In the related art, for dynamic rendering of the hair of a person or an animal, it is usually necessary to first simulate the motion states of hair strands based on hair strand data to obtain the simulated poses of the hair strands in the next frame of image, and then, perform rendering based on the simulated poses, so that the hair strand exhibits the motion state. However, since the hair strand data covers a huge number of hair strands, it is difficult to simulate each hair strand independently while meeting the requirements of real-time rendering. Therefore, in the related art, the solutions typically simulate a small number of guide hair strands in the hair strand data, and then apply the simulated pose of each guide hair strand to a large number of regular hair strands corresponding to the guide hair strand, thereby implementing fast simulation of all the hair strands. However, in the above solutions in the related art, after applying the simulated pose of the guide hair strand to the corresponding regular hair strands, the pose attributes of the regular hair strands are overwritten. As a result, the large number of regular hair strands corresponding to the same guide hair strand have a relatively high posture similarity, resulting in loss of hair strand details. Consequently, using the hair strands with the relatively high posture similarity for image rendering results in the generated rendered hair strand image with low realism and poor visual effects. An embodiment of the present disclosure provides a hair strand processing method to resolve the above problems.

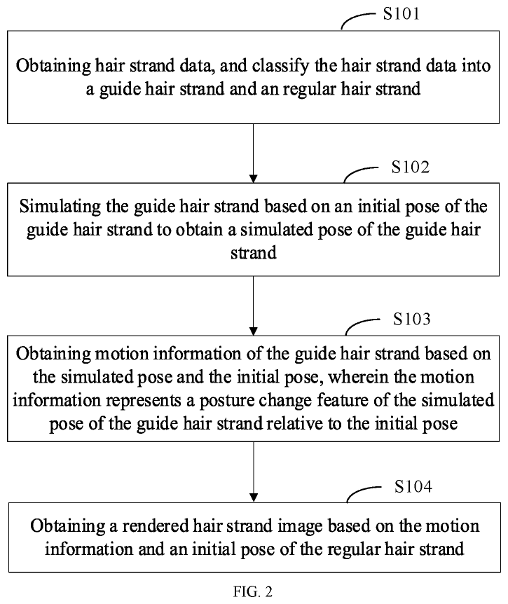

FIG. 2 is a first schematic flowchart of the hair strand processing method according to this embodiment of the present disclosure. The method in this embodiment may be applied to a terminal device. The hair strand processing method includes:

Step S101: Obtain hair strand data, and classify the hair strand data into a guide hair strand and a regular hair strand.

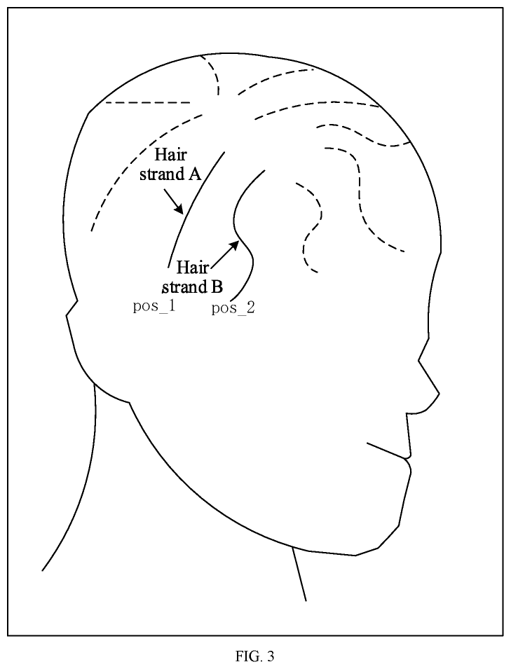

For example, referring to the description of the above application scenario, the hair strand data is data used to represent hair strands constituting the hair of a person or an animal. For example, the hair strand data is used to represent an initial pose of a guide hair strand and an initial pose of a regular hair strand corresponding to the guide hair strand. A pose of a corresponding hair strand may be determined by using the hair strand data, and the pose refers to a position and a posture of the hair strand. FIG. 3 is a schematic diagram of poses of hair strands according to an embodiment of the present disclosure. In an example of rendering the hair of a person, as shown in FIG. 3, massive hair strands constituting the hair include a hair strand A and a hair strand B. A pose corresponding to the hair strand A is a pose pos_1 and a pose corresponding to the hair strand B is a pose pos_2. As shown in the figure, first, the hair strand A and the hair strand B are located at different positions. Second, the hair strand A and the hair strand B have different postures, more specifically, the hair strand A corresponds to “straight hair”, and the hair strand B corresponds to “curly hair”. Based on the poses corresponding to the hair strands, it is possible to distinguish between positions and postures of different hair strands, thereby enabling hair strands at different positions to exhibit different hair strand postures.

Further, the hair strand data includes data of two types of hair strands: data of guide hair strands and data of regular hair strands. The guide hair strands are used to represent the overall style, and/or the hair strand distribution, and/or the hair strand orientation of the hair of a person or an animal, playing a role similar to that of a “skeleton”. In subsequent steps, by calculating the pose changes of the guide hair strands and their constraint relationship with other elements in the virtual environment, simulation calculations are performed on the guide hair strands, thereby implementing motion of the hair and interaction with the external environment. The regular hair strands, on the other hand, are used to further fill the gaps between the guide hair strands on the basis of the guide hair strands, thereby making the overall hair more voluminous. The regular hair strands do not require simulation calculations based on motion states, and thus have a smaller calculation load compared to simulation calculations for the guide hair strands. Typically, one guide hair strand corresponds to a plurality of regular hair strands. For example, the ratio of guide hair strands to regular hair strands is 1:100. By setting a small number of guide hair strands and corresponding regular hair strands, a load of hair strand simulation calculation can be reduced.

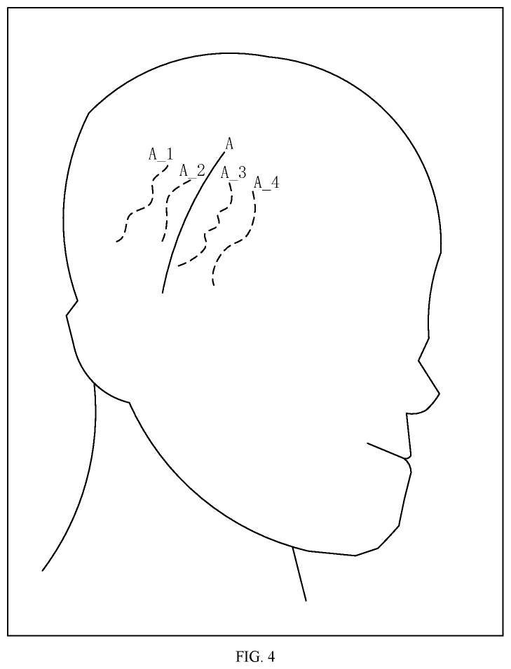

Further, the hair strand data includes pose data corresponding to each of the guide hair strand and the regular hair strand in their initial states, i.e., the initial pose and the initial pose. Through the hair strand data, the initial pose of the guide hair strand can be determined, and an initial pose corresponding to each of a group of regular hair strands corresponding to the guide hair strand can be determined. FIG. 4 is a schematic diagram of poses of a guide hair strand and regular hair strands according to an embodiment of the present disclosure. As shown in FIG. 4, based on the hair strand data, a hair strand A (shown as A in the figure) is a guide hair strand, and a hair strand A_1, a hair strand A_2, a hair strand A_3, a hair strand A_4 (shown as A_1, A_2, A_3, and A_4 respectively in the figure) and the like located near the hair strand A are regular hair strands. The hair strand A has an initial pose pos_1, the hair strand A_2 has an initial pose pos_2, the hair strand A_3 has an initial pose pos_3, and the hair strand A_4 has an initial pose pos_4. As shown in the figure, different regular hair strands corresponding to the same guide hair strand are located at different positions and have different postures, that is, have different initial poses. In the subsequent processing steps, each regular hair strand is simulated on the basis of the different initial pose owned by the regular hair strand, so that the regular hair strand retains a part of the initial pose.

A pose (the initial pose) of the guide hair strand in the initial state and a pose (the initial pose) of the regular hair strand in the initial state may be preset based on a specific need of a target application, or may be generated randomly. This is not specifically limited herein. For a group of regular hair strands corresponding to the same guide hair strand, initial poses corresponding to the regular hair strands are not exactly the same.

Step S102: Process the guide hair strand based on the initial pose of the guide hair strand to obtain a simulated pose of the guide hair strand.

For example, based on the guide hair strand in the hair strand data, the guide hair strand is simulated, that is, a pose (i.e., the simulated pose) of the guide hair strand in a next frame is predicted and simulated. In implementations in which the pose of the guide hair strand is changed in the next frame, one possible implementation is as follows: The guide hair strand undergoes random motion. To be specific, on the basis of the initial pose of the guide hair strand, the initial pose randomly changes within a specific range, to obtain a pose (i.e., the simulated pose) different from the initial pose. More specifically, for example, both the guide hair strand and the regular hair strand in the hair strand data are composed of a plurality of hair strand particles, and a distance between the hair strand particles is fixed. In this case, there is a distance constraint between adjacent hair strand particles. By applying a random position offset to each hair strand particle of the guide hair strand, the simulated pose of the guide hair strand can be obtained.

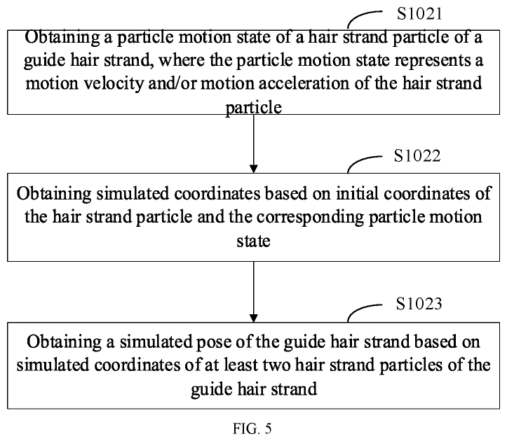

In another possible implementation, to simulate real performance of a hair strand in an environment, the simulated pose of the guide hair strand is simulated based on impact of the environment on the guide hair strand, for example, motion of the hair driven by a movement of a person or an animal within an image. Specifically, the hair strand data includes initial coordinates of a hair strand particle constituting the guide hair strand. As shown in FIG. 5, a specific implementation of step S102 includes:

Step S1021: Obtain a particle motion state of the hair strand particle of the guide hair strand, wherein the particle motion state represents a motion velocity and/or motion acceleration of the hair strand particle.

Step S1022: Obtain simulated coordinates based on the initial coordinates of the hair strand particle and the corresponding particle motion state.

Step S1023: Obtain the simulated pose of the guide hair strand based on simulated coordinates of at least two hair strand particles of the guide hair strand.

For example, in this embodiment, the hair strand particle of the guide hair strand is a hair strand particle, and correspondingly, a hair strand particle of the regular hair strand is a hair strand particle of a regular hair strand, which will be described in subsequent steps. A particle motion state of a hair strand particle refers to a motion velocity and/or motion acceleration of the hair strand particle in a motion state. The motion velocity and the motion acceleration of the hair strand particle are generated by traction forces exerted on the hair strand particle by other hair strand particles on the guide hair strand that are adjacent to the hair strand particle. Optionally, the motion velocity and the motion acceleration of the hair strand particle are alternatively generated by a constraint force exerted on the hair strand particle by external objects (for example, other hair strands or obstacles in the environment) in the image environment.

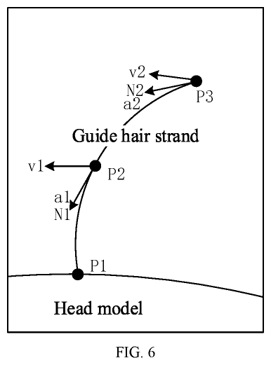

FIG. 6 is a schematic diagram of particle motion states of hair strand particles according to an embodiment of the present disclosure. As shown in the figure, a guide hair strand LI contains a hair strand particle P1, a hair strand particle P2, and a hair strand particle P3 (shown as P1, P2, and P3 in the figure). The hair strand particle P1 is a hair root particle, and coordinates are, that is, the hair strand particle P1 is located on a surface of a head model (correspondingly located at a hair root of the scalp). When the head model moves, motion of the hair strand particle P1 is driven, resulting in corresponding motion of the hair strand particle P1. Thereafter, the hair strand particle P2 adjacent to the hair strand particle P1 undergoes motion under action of a traction force N1 from the hair strand particle P1, making the hair strand particle P2 produce a corresponding velocity v2 and acceleration a3 (in the same direction as N1). Further, the hair strand particle P3 adjacent to the hair strand particle P2 is also subject to a traction force N2 from the hair strand particle P2, producing a corresponding velocity v3 and acceleration a3 (in the same direction as N2). The velocities and acceleration of the hair strand particles shown in the figure are merely illustrative. A corresponding particle motion state of each hair strand particle is subject to impact of a specific model parameter of the guide hair strand, and may be obtained by simulation based on the model parameter of the guide hair strand by using an existing dynamics simulation tool. A specific implementation is not described.

Further, for example, after the particle motion state of each hair strand particle on the guide hair strand is obtained, pose update is performed on initial coordinates of a corresponding hair strand particle based on the particle motion state of each hair strand particle of the guide hair strand in the hair strand data, to obtain simulated coordinates corresponding to each hair strand particle. Specifically, a method for calculating simulated coordinates based on initial coordinates of a hair strand particle and a corresponding particle motion state may be implemented by using Equation (1):

$${x}_{t + 1} = {x}_{t} + {v}_{t} \times dt + {a}_{t} \times {dt}^{2} , \qquad ( 1 )$$

where xₜ₊₁ is position coordinates of the hair strand particle at a moment t+1, xₜ is position coordinates of the hair strand particle at a moment t, vₜ is a velocity of the hair strand particle at the moment t, aₜ is acceleration of the hair strand particle at the moment t, and dt is a time interval between two moments (for example, the moment t and the moment t+1). When

$$t = 0 , {x}^{t - 1}$$

is simulated coordinates; and x^{t} is initial coordinates, and vₜ and a^{t} are particle motion states. For example, after the simulated coordinates are obtained, to implement dynamic rendering of the hair strand, simulated coordinates at a moment t=2 may be further calculated based on simulated coordinates at a moment t=1. To be specific, the initial coordinates in the above step are updated to the simulated coordinates at the moment t=1, and the simulated coordinates at moment t=2 are calculated based on the updated initial coordinates, thereby implementing real-time dynamic simulation of the guide hair strand. Specific processes are similar and details are not described again.

Then, the simulated pose of the guide hair strand may be obtained based on the simulated coordinates of the at least two hair strand particles of the guide hair strand. For example, the simulated coordinates of the hair strand particle corresponding to the guide hair strand are three-dimensional coordinates, which can be represented by an array. By combining the simulated coordinates of the hair strand particles, a corresponding simulated pose may be obtained, and the simulated pose may be an array, a matrix, or a structural body. Details are not specifically described.

Step S103: Obtain motion information of the guide hair strand based on the simulated pose and the initial pose, wherein the motion information represents a posture change feature of the simulated pose of the guide hair strand relative to the initial pose.

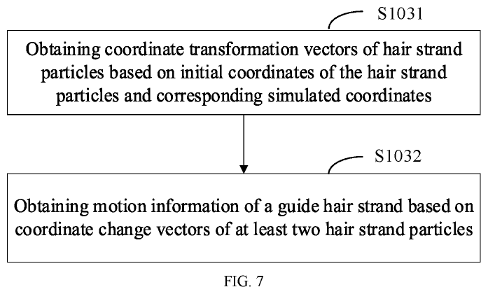

For example, after the simulated pose of the guide hair strand is obtained, comparative calculation is performed based on the simulated pose and the initial pose in the hair strand data, so that the posture change feature, i.e., the motion information, between the simulated pose and the initial pose can be obtained. For example, the motion information may be represented based on a mapping vector between coordinates of a hair strand particle of the guide hair strand in the initial pose and coordinates of the hair strand particle in the simulated pose. Specifically, the initial pose includes initial coordinates of the at least two hair strand particles corresponding to the guide hair strand. The simulated pose includes the simulated coordinates of the at least two hair strand particles corresponding to the guide hair strand. As shown in FIG. 7, specific implementation steps of step S103 include:

Step S1031: Obtain a coordinate transformation vector of the hair strand particle based on the initial coordinates of the hair strand particle and the corresponding simulated coordinates.

Step S1032: Obtain the motion information of the guide hair strand based on the coordinate change vectors of the at least two hair strand particles.

For example, for the same hair strand particle in the guide hair strand, if the guide hair strand undergoes motion when the guide hair strand is in the initial pose and in the simulated pose, the hair strand particle has corresponding different coordinates, i.e., initial coordinates and simulated coordinates. For example, the initial coordinates are x₀, and the simulated coordinates are x₁. There is a mapping relationship between initial coordinates and simulated coordinates:

$${x}_{1} = T ( {x}_{2} )$$

T is coordinate transformation between the initial coordinates and the simulated coordinates, i.e., a coordinate transformation vector of the hair strand particle. Then, based on a combination of the coordinate change vectors of the at least two hair strand particles, the motion information of the guide hair strand is obtained. For example, the guide hair strand A includes three hair strand particles, which are respectively P1, P2, and P3. In this case, running information corresponding to the guide hair strand A is Info=[T₁, T₂, T₃], where T₁ is a coordinate transformation vector of the hair strand particle P1, T₂ is a coordinate transformation vector of the hair strand particle P2, and T₃ is a coordinate transformation vector of the hair strand particle P3.

Step S104: Obtain a rendered hair strand image based on the motion information and the initial pose of the regular hair strand.

For example, after the motion information of the guide hair strand is obtained, the motion information of the guide hair strands is transferred to the corresponding regular hair strand, so that the regular hair strand produces the same pose change as the guide hair strand on the basis of the initial pose (the initial pose), thereby obtaining a second simulated hair strand corresponding to the regular hair strand. Then, image rendering is performed based on the second simulated hair strand, so that the rendered hair strand image can be obtained.

For example, a specific implementation of step S104 includes:

Step S1041: Simulate the initial pose of the regular hair strand based on the motion information to obtain a simulated pose of the regular hair strand.

Step S1042: Perform image rendering based on the simulated pose of the regular hair strand to obtain the rendered hair strand image.

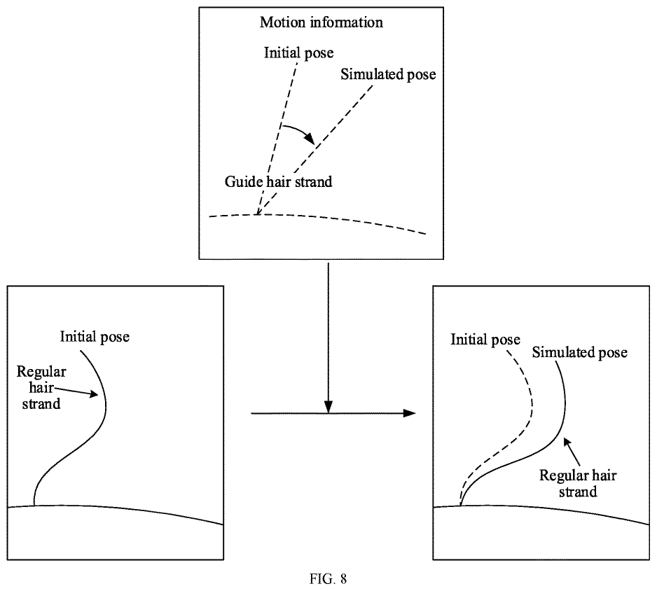

FIG. 8 is a schematic diagram of a process of generating a simulated pose of a regular hair strand according to an embodiment of the present disclosure. As shown in FIG. 8, the motion information is used to represent the posture change feature of the guide hair strand. For example, in the figure, the posture change feature represented by the motion information indicates that the guide hair strand rotates clockwise by 30 degrees. After the motion information is transferred to regular hair strands, based on the motion information, the regular hair strands rotate with the same posture change feature on the basis of the initial pose, thereby generating a simulated pose. Then, based on the simulation result, i.e., the simulated pose, of the regular hair strands, image rendering is performed using a renderer, for example, to obtain a rendered hair strand image composed of regular hair strands. Thereafter, the rendered hair strand image can be displayed in a corresponding display interface as required by the target application. Through the above steps, the regular hair strands retain the original hair strand feature (initial pose) while incorporating the motion information of the guide hair strand, thereby indirectly implementing the driving of the regular hair strands by the external environment. Since regular hair strands in one group of regular hair strands corresponding to the same guide hair strand do not all have identical initial poses, second simulated hair strands for the regular hair strands in the group of regular hair strands corresponding to the same guide hair strand are not identical either. This produces more differences between different regular hair strands, thereby making the rendered hair strand image generated more realistic and natural.

In this embodiment, hair strand data is obtained, where the hair strand data is used to represent an initial pose of a guide hair strand and an initial pose of a regular hair strand corresponding to the guide hair strand; the guide hair strand is simulated based on the hair strand data to obtain a simulated pose of the guide hair strand; motion information of the guide hair strand is obtained based on the simulated pose and the initial pose, where the motion information represents a posture change feature of the simulated pose of the guide hair strand relative to the initial pose; and a rendered hair strand image is obtained based on the motion information and the initial pose of the regular hair strand. Through the simulated pose of the guide hair strand, the motion information representing the pose change feature of the guide hair strand is obtained. In addition, the motion information is used as a pose change amount to redirect the regular hair strands, allowing the regular hair strands to incorporate the motion information on the basis of the original initial pose to obtain the corresponding simulation result, thereby obtaining the rendered hair strand image. Since the regular hair strands have different initial poses, after redirection in combination with the corresponding motion information, simulation results are subject to impact of the initial poses of the regular hair strands. As a result, the simulation results of the regular hair strands are also different, thereby retaining hair strand details and improving the realism and visual effects of the rendered hair strand image.

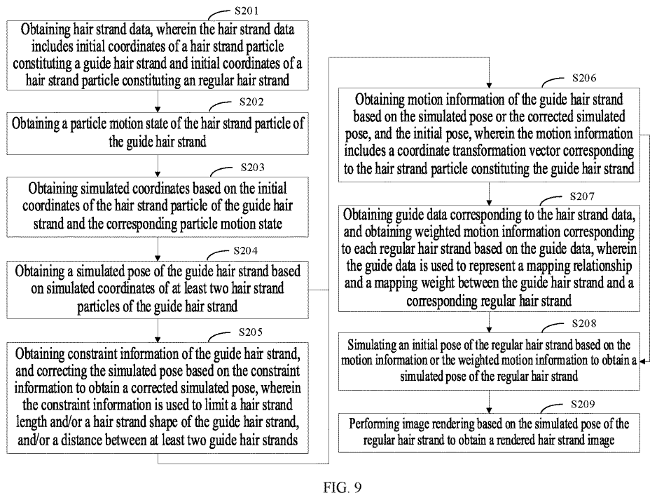

FIG. 9 is a second schematic flowchart of a hair strand processing method according to an embodiment of the present disclosure. In this embodiment, a detailed description is provided by adding steps of correcting the motion information on the basis of the embodiment shown in FIG. 2. The hair strand processing method includes:

Step S201: Obtain hair strand data, wherein the hair strand data includes initial coordinates of a hair strand particle constituting a guide hair strand and initial coordinates of a hair strand particle constituting a regular hair strand.

Step S202: Obtain a particle motion state of the hair strand particle of the guide hair strand.

For example, the hair strand data contains initial poses of different guide hair strands, and the initial poses of the guide hair strands are represented by initial coordinates of hair strand particles of the guide hair strands. Correspondingly, the hair strand data also contains initial poses of regular hair strands corresponding to the guide hair strands, and the initial poses of the regular hair strands are represented by initial coordinates of hair strand particles of the regular hair strands of the regular hair strands. Then, when the guide hair strands move or exhibit a motion tendency, the hair strand particles of the guide hair strands have corresponding particle motion states, for example, including a motion velocity, motion acceleration, and the like of a first particle hair strand. A manner for obtaining the particle motion state may be implemented by using a dynamics simulation tool, which has been described in the embodiment shown in FIG. 2. Details are not described herein again.

Step S203: Obtain simulated coordinates based on the initial coordinates of the hair strand particle of the guide hair strand and the corresponding particle motion state.

For example, after the particle motion state of the hair strand particle is obtained, coordinate transformation is performed on the initial coordinates of the hair strand particle based on the particle motion state, so that the corresponding simulated coordinates can be obtained. For example, the particle motion state includes a first motion velocity of the hair strand particle and first motion acceleration of the hair strand particle. The simulated coordinates can be obtained by respectively performing first integration and second integration on the first motion velocity and the first motion acceleration, and then performing addition with the initial coordinates. For a specific implementation, refer to a related description of Equation (1) in the embodiment shown in FIG. 2. Certainly, it can be understood that, in another possible implementation, the simulated coordinates can be obtained simply by performing the first integration on the first motion velocity or performing the second integration on the first motion acceleration. Details are not described herein.

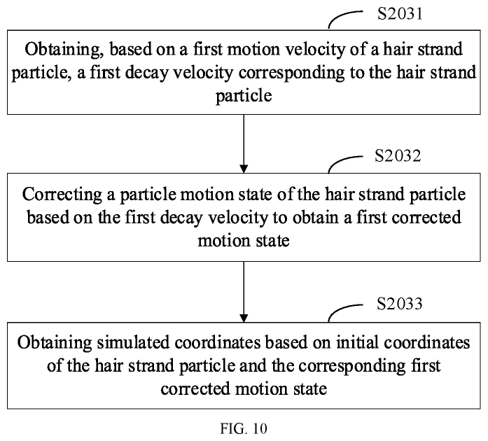

In a possible implementation, as shown in FIG. 10, a specific implementation of step S203 includes:

Step S2031: Obtain a first decay velocity corresponding to the hair strand particle based on the first motion velocity of the hair strand particle.

Step S2032: Correct the particle motion state of the hair strand particle based on the first decay velocity to obtain a first corrected motion state.

Step S2033: Obtain the simulated coordinates based on the initial coordinates of the hair strand particle and the corresponding first corrected motion state.

In a real environment, a hair strand in hair is subject to external forces such as a friction force during motion to form frictional damping. To improve visual realism of the hair strand in a process of rendering a hair strand image, in this embodiment, a matched decay velocity is applied to the hair strand particle in the guide hair strand by using the motion velocity of the hair strand particle in the guide hair strand. The first motion velocity of the hair strand particle is positively correlated to the corresponding first decay velocity, that is, a greater first motion velocity indicates a greater first decay velocity. Thereafter, the corresponding first decay velocity is subtracted from the first motion velocity to obtain a particle motion state of the hair strand particle, on the guide hair strand, to which the frictional damping is applied. In other words, the first corrected motion state (for example, a corrected motion velocity and corrected motion acceleration of the hair strand particle) is obtained. Thereafter, the simulated coordinates are obtained based on the initial coordinates of the hair strand particle and the corresponding first corrected motion state, thereby further improving accuracy of the simulated coordinates and improving realism of a hair strand rendering effect. A method for obtaining the corresponding simulated coordinates based on the initial coordinates of the hair strand particle and the corresponding particle motion state (the first corrected motion state) has been described in the previous embodiment. Details are not described herein again.

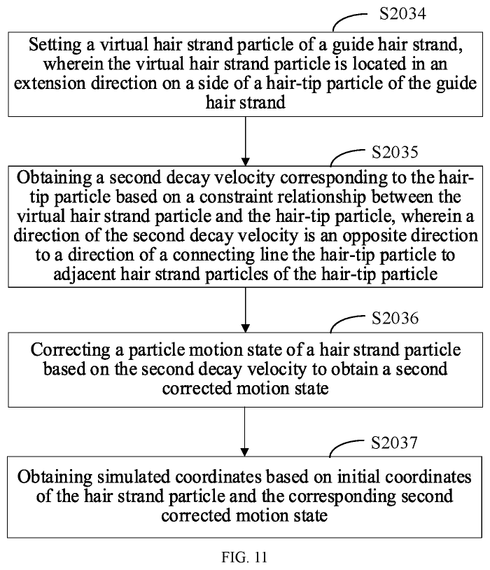

In another possible implementation, as shown in FIG. 11, a specific implementation of step S203 includes:

Step S2034: Set a virtual hair strand particle of the guide hair strand, wherein the virtual hair strand particle is located in an extension direction on a side of a hair-tip particle of the guide hair strand.

Step S2035: Obtain a second decay velocity corresponding to the hair-tip particle based on a position constraint relationship between the virtual hair strand particle and the hair-tip particle, wherein a direction of the second decay velocity is an opposite direction to a direction of a connecting line from the hair-tip particle to adjacent hair strand particles of the hair-tip particle.

Step S2036: Correct the particle motion state of the hair strand particle based on the second decay velocity to obtain a second corrected motion state.

Step S2037: Obtain the simulated coordinates based on the initial coordinates of the hair strand particle and the corresponding second corrected motion state.

For example, motion of each hair strand particle on the guide hair strand is mainly generated based on traction forces from other hair strand particles adjacent to the hair strand particle. In one aspect, a hair strand particle at the root of the guide hair strand (i.e., a hair root particle) is directly fixed to the surface of the head model, and is mainly subject to impact of a constraint force of the head model. Therefore, a position thereof is subject to fixed motion along with motion of the head model, and this is equivalent to a driving force source for motion of the guide hair strand. In this case, the position of the hair root particle is not deviated. In another aspect, a hair strand particle in a middle part of the guide hair strand is subject to constraint forces (a bidirectional constraint) of hair strand particles on both adjacent sides. Therefore, a motion position of the hair strand particle in the middle part is also usually stable. However, the last hair strand particle (i.e., the hair-tip particle) located at an outer end of the guide hair strand is subject to only a constraint from an adjacent hair strand particle on one side. Consequently, when the last hair strand particle is simulated, a problem of an unstable motion state occurs, that is, a problem of “abnormal shaking of a hair tip” occurs in visual presentation.

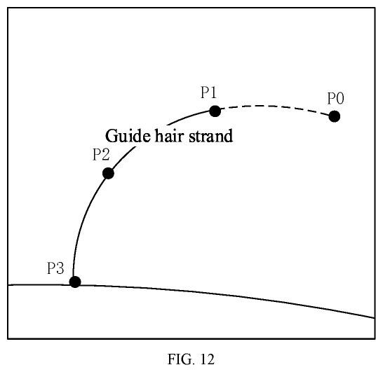

To resolve the above problem, in this embodiment of the present disclosure, the virtual hair strand particle is generated after the hair strand particle of the guide hair strand. Coordinates of the virtual hair strand particle may be determined based on coordinates of the hair-tip particle and at least one hair strand particle before the hair-tip particle. More specifically, for example, based on the coordinates of the hair-tip particle and the at least one adjacent hair strand particle before the hair-tip particle, a corresponding hair strand curvature and a distance between the hair strand particles are calculated. Then, simulated coordinates of the virtual hair strand particle are obtained based on the calculated hair strand curvature and the calculated distance between the hair strand particles. FIG. 12 is a schematic diagram of a virtual hair strand particle according to an embodiment of the present disclosure. As shown in FIG. 12, a hair-tip particle P1 of the guide hair strand and two hair strand particles P2 and P3 before the hair-tip particle (shown as P1, P2, and P3 in the figure) are obtained based on the hair strand data. Then, based on distances between coordinates of P1, P2, and P3, and a corresponding hair strand curvature, a position of a virtual hair strand particle P0 (shown as P0 in the figure) is obtained to complete construction of the virtual hair strand particle.

Thereafter, further, based on a dynamics simulation tool, the second decay velocity corresponding to the hair-tip particle is calculated by utilizing the position constraint relationship between the virtual hair strand particle and the hair-tip particle. The second decay velocity is a velocity component of the hair-tip particle caused by a traction force from the virtual hair strand particle to the hair-tip particle. The direction of the second decay velocity is an opposite direction to the direction of the connecting line from the hair-tip particle to the adjacent hair strand particles of the hair-tip particle. Then, in combination with the second decay velocity pair of the hair-tip particle, the particle motion state of the hair strand particle is corrected to obtain the second corrected motion state, for example, obtain a corrected motion velocity and corrected motion acceleration. Further, the simulated coordinates are obtained based on the corrected second corrected motion state and the initial coordinates of the hair strand particle. A specific implementation is similar to the implementation of obtaining the simulated coordinates based on the first corrected motion state and the initial coordinates of the hair strand particle, which has been described in detail in the previous embodiment. Details are not described herein again.

In the steps in this embodiment, the hair-tip particle is constrained by constructing the virtual hair strand particle, thereby improving motion stability of the hair-tip particle and improving a visual effect of the rendered hair strand image.

Certainly, it can be understood that, the two methods for obtaining the simulated coordinates in the embodiments corresponding to FIG. 10 and FIG. 11 may be further used in combination. To be specific, in a possible implementation, a first corrected motion state and a second corrected motion state corresponding to a hair strand particle are separately obtained. Then, coordinate transformation is performed on initial coordinates successively based on the first corrected motion state and the second corrected motion states to obtain simulated coordinates, thereby obtaining more accurate simulated coordinates, and improving a visual effect of a rendered hair strand image.

Step S204: Obtain the simulated pose of the guide hair strand based on simulated coordinates of the at least two hair strand particles of the guide hair strand.

Optionally, after step S204, the method further includes:

Step S205: Obtain constraint information of the guide hair strand, and correct the simulated pose based on the constraint information to obtain a corrected simulated pose, wherein the constraint information is used to limit a hair strand length and/or a hair strand shape of the guide hair strand, and/or a distance between at least two guide hair strands.

For example, the guide hair strand may also configure the constraint information, and the constraint information is used to limit the hair strand length and/or the hair strand shape of the guide hair strand, and/or the distance between the at least two guide hair strands. More specifically, for example, the constraint information is used to limit the hair strand length of the guide hair strand to be within a preset length interval; and the constraint information is used to limit the hair strand shape, for example, a curvature, of the guide hair strand to be within a preset curvature interval; thereby ensuring actual realism of the guide hair strand. The constraint information is used to limit a distance between guide hair strands from being greater than a length threshold, thereby ensuring proper distribution of the guide hair strands and improving an overall visual effect of the rendered hair strand image.

Further, the constraint information of the guide hair strand may be preset based on a requirement or automatically generated based on an appearance model of a person or an animal. This is not specifically described herein. After the simulated pose is obtained, the simulated pose of the guide hair strand is corrected by using the constraint information to obtain the corrected simulated pose, thereby making a simulation result of the guide hair strand more realistic and improving a rendering effect of a subsequent rendered hair strand image.

Step S206: Obtain the motion information of the guide hair strand based on the simulated pose or the corrected simulated pose, and the initial pose, wherein the motion information includes a coordinate transformation vector corresponding to the hair strand particle constituting the guide hair strand.

In the embodiment shown in FIG. 2, the specific implementation of determining the motion information based on the simulated pose and the initial pose of the guide hair strand is described, which is similar to a specific implementation of determining the motion information based on the corrected simulated pose and the initial pose in the step in this embodiment. Details are not described herein again. For details, refer to specific descriptions of relevant steps in the embodiment shown in FIG. 2.

Optionally, after step S206, the method further includes:

Step S207: Obtain guide data corresponding to the hair strand data, and obtain weighted motion information corresponding to each regular hair strand based on the guide data, wherein the guide data is used to represent a mapping relationship and a mapping weight between the guide hair strand and the corresponding regular hair strand.

For example, the guide data is data representing the mapping relationship and the mapping weight between the guide hair strand and the corresponding regular hair strand. The guide data may be data contained in the hair strand data, or may be separate data corresponding to the hair strand data. In a possible implementation, the guide data contains an index identifier corresponding to each guide hair strand and a hair strand identifier of a regular hair strand corresponding to each guide hair strand. Further, the guide data also includes a mapping right corresponding to each regular hair strand. The mapping right is, for example, a normalized value representing a degree of impact imposed by running of the guide hair strand on the regular hair strand, and a value range is, for example, (0, 1]. After motion information corresponding to each regular hair strand is weighted by using the mapping weight, weighted motion information corresponding to each regular hair strand is obtained.

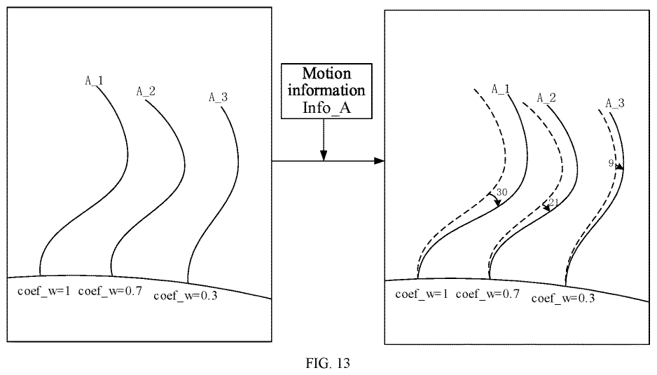

FIG. 13 is a schematic diagram of generating weighted motion information according to an embodiment of the present disclosure. As shown in FIG. 13, corresponding motion information generated based on a simulated pose of the guide hair strand A is motion information Info_A, and the running information is used to enable the guide hair strand to rotate counterclockwise by 30 degrees. Based on the guide data, regular hair strands corresponding to the guide hair strand A include a regular hair strand A_1, a regular hair strand A_2, and a regular hair strand A_3 (shown as A_1, A_2, and A_3 in the figure). A mapping weight corresponding to the regular hair strand A_1 is coef_w=1, a mapping weight corresponding to the regular hair strand A_2 is coef_w=0.7, and a mapping weight corresponding to the regular hair strand A_1 is coef_w=0.3. In this case, based on the guide data, generated weighted motion information of the regular hair strand A_1 is Info_A1, and is used to enable the regular hair strand A_1 to rotate counterclockwise by 30 degrees (shown as 30, the same as below). Generated weighted motion information of the regular hair strand A_2 is Info_A2, and is used to enable the regular hair strand A_2 to rotate counterclockwise by 21 degrees (a product of 30 degrees multiplied by the weight factor 0.7, the same below). Generated weighted motion information of the regular hair strand A_3 is Info_A3, and is used to enable the regular hair strand A_3 to rotate counterclockwise by 9 degrees.

In this embodiment, the mapping weights of the regular hair strands corresponding to the guide hair strand are further determined by using the guide data, thereby making presentation styles of the regular hair strands more diverse, increasing hair strand details, and improving a rendering effect of the rendered hair strand image.

Step S208: Simulate the initial pose of the regular hair strand based on the motion information or the weighted motion information to obtain the simulated pose of the regular hair strand.

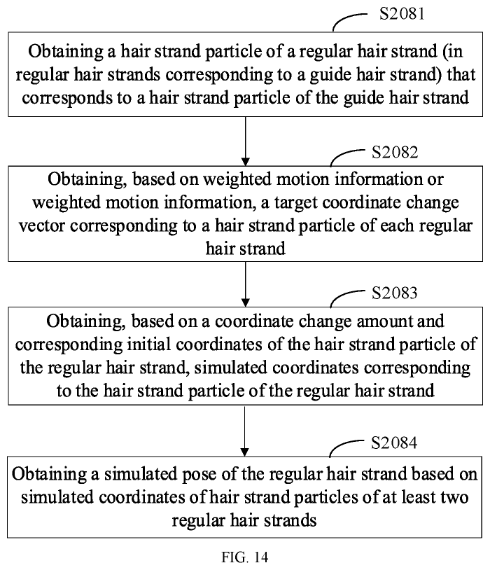

In a possible implementation, as shown in FIG. 14, a specific implementation of step S208 includes:

Step S2081: Obtain, based on a correspondence between the guide hair strand and the regular hair strand, a hair strand particle of the regular hair strand that corresponds to the hair strand particle of the guide hair strand.

Step S2082: Obtain, based on the weighted motion information or the weighted motion information, a target coordinate change vector corresponding to a hair strand particle of each regular hair strand.

Step S2083: Obtain, based on a coordinate change amount and corresponding initial coordinates of the hair strand particle of the regular hair strand, simulated coordinates corresponding to the hair strand particle of the regular hair strand.

Step S2084: Obtain the simulated pose of the regular hair strand based on simulated coordinates of hair strand particles of at least two regular hair strands.

For example, the hair strand particle of the regular hair strand (in the regular hair strands corresponding to the guide hair strand) that corresponds to the hair strand particle is obtained based on the guide data. The number of hair strand particles of the regular hair strand in the regular hair strands is the same as the number of hair strand particles of the corresponding guide hair strand. Therefore, based on a particle index of the hair strand particle and a particle index of the hair strand particle of the regular hair strand, the hair strand particle of the regular hair strand that corresponds to the hair strand particle can be obtained. Then, the weighted motion information or the weighted motion information contains a coordinate change vector corresponding to a hair strand particle of each guide hair strand. Based on the mapping relationship determined in the previous step, the target coordinate change vector corresponding to the hair strand particle of each regular hair strand is obtained. A specific implementation of the coordinate change vector has been described in relevant steps in the embodiment shown in FIG. 2. Details are not described herein again. Further, coordinate transformation is performed on the initial coordinates corresponding to the hair strand particle of the regular hair strand by using the target coordinate change vector, so that the motion information of the guide hair strand is transferred to the corresponding regular hair strand, to enable the regular hair strand to carry out motion similar to that of the guide hair strand. The simulated coordinates corresponding to the hair strand particle of the regular hair strand are obtained. Further, the simulated pose of the regular hair strand is obtained based on a set of the simulated coordinates of the hair strand particles of the at least two regular hair strands in the regular hair strands.

Step S209: Perform image rendering based on the simulated pose of the regular hair strand to obtain the rendered hair strand image.

In this embodiment, the implementations of step S204 and step 209, and the implementations of step S102 and step 104 in the embodiment shown in FIG. 2 have been described. Details are not described herein again.

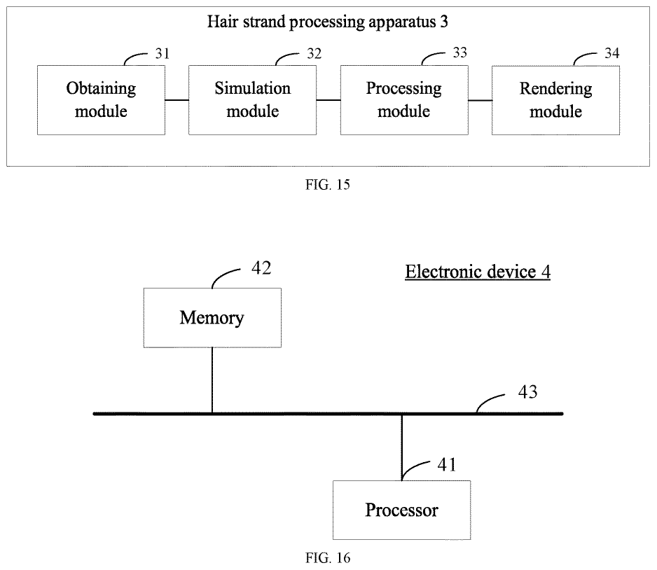

Corresponding to the hair strand processing method in the above embodiments, FIG. 15 is a block diagram of a structure of a hair strand processing apparatus according to an embodiment of the present disclosure. For ease of illustration, only parts related to this embodiment of the present disclosure are shown. Referring to FIG. 15, a hair strand processing apparatus 3 includes:
an obtaining module 31 configured to obtain hair strand data, wherein the hair strand data is used to represent an initial pose of a guide hair strand and an initial pose of a regular hair strand corresponding to the guide hair strand;
a simulation module 32 configured to simulate the guide hair strand based on the hair strand data to obtain a simulated pose of the guide hair strand;
a processing module 33 configured to obtain motion information of the guide hair strand based on the simulated pose and the initial pose, wherein the motion information represents a posture change feature of the simulated pose of the guide hair strand relative to the initial pose; and
a rendering module 34 configured to obtain a rendered hair strand image based on the motion information and an initial pose of the regular hair strand.

In an embodiment of the present disclosure, the hair strand data includes initial coordinates of a hair strand particle constituting the guide hair strand. The simulation module 32 is specifically configured to: obtain a particle motion state of the hair strand particle of the guide hair strand, where the particle motion state represents a motion velocity and/or motion acceleration of the hair strand particle; obtain simulated coordinates based on the initial coordinates of the hair strand particle and the corresponding particle motion state; and obtain the simulated pose of the guide hair strand based on simulated coordinates of at least two hair strand particles of the guide hair strand.

In an embodiment of the present disclosure, the particle motion state includes a first motion velocity of the hair strand particle, and when obtaining the simulated coordinates based on the initial coordinates of the hair strand particle and the corresponding particle motion state, the simulation module 32 is specifically configured to: obtain a first decay velocity corresponding to the hair strand particle based on the first motion velocity of the hair strand particle; correct the particle motion state of the hair strand particle based on the first decay velocity to obtain a first corrected motion state; and obtain the simulated coordinates based on the initial coordinates of the hair strand particle and the corresponding first corrected motion state.

In an embodiment of the present disclosure, the hair strand particles of the guide hair strand include a hair-tip particle, and when obtaining the simulated coordinates based on the initial coordinates of the hair strand particle and the corresponding particle motion state, the simulation module 32 is specifically configured to: generate a virtual hair strand particle after the hair-tip particle of the guide hair strand; obtain a second decay velocity corresponding to the hair-tip particle based on a position constraint relationship between the virtual hair strand particle and the hair-tip particle, where a direction of the second decay velocity is an opposite direction to a direction of a connecting line from the hair-tip particle to adjacent hair strand particles of the hair-tip particle; correct the particle motion state of the hair strand particle based on the second decay velocity to obtain a second corrected motion state; and obtain the simulated coordinates based on the initial coordinates of the hair strand particle and the corresponding second corrected motion state.

In an embodiment of the present disclosure, the rendering module 34 is specifically configured to: simulate the initial pose of the regular hair strand based on the motion information to obtain a simulated pose of the regular hair strand; and perform image rendering based on the simulated pose of the regular hair strand to obtain the rendered hair strand image.

In an embodiment of the present disclosure, the motion information includes a coordinate transformation vector corresponding to the hair strand particle constituting the guide hair strand, and the initial pose includes initial coordinates of hair strand particles of at least two regular hair strands in regular hair strands. When simulating the initial pose of the regular hair strand based on the motion information to obtain the simulated pose of the regular hair strand, the rendering module 34 is specifically used to: obtain the hair strand particle of the regular hair strand (in regular hair strands corresponding to the guide hair strand) that corresponds to the hair strand particle of the guide hair strand; obtain, based on the motion information, a coordinate change vector corresponding to a hair strand particle of each regular hair strand; obtain, based on the coordinate change amount and corresponding initial coordinates of the hair strand particle of the regular hair strand, simulated coordinates corresponding to the hair strand particle of the regular hair strand; and obtain the simulated pose of the regular hair strand based on simulated coordinates of hair strand particles of at least two regular hair strands.

In an embodiment of the present disclosure, the initial pose includes initial coordinates of the at least two hair strand particles corresponding to the guide hair strand; and the simulated pose includes the simulated coordinates of the at least two hair strand particles corresponding to the guide hair strand. The processing module 33 is specifically configured to: obtain a coordinate transformation vector of the hair strand particle based on the initial coordinates of the hair strand particle and the corresponding simulated coordinates; and obtain the motion information of the guide hair strand based on coordinate change vectors of the at least two hair strand particles.

In an embodiment of the present disclosure, the obtaining module 31 is further configured to: obtain guide data corresponding to the hair strand data, where the guide data is used to represent a mapping relationship and a mapping weight between the guide hair strand and the corresponding regular hair strand. The rendering module 34 is specifically configured to: obtain weighted motion information corresponding to each regular hair strand based on the guide data; and obtain the rendered hair strand image based on the weighted motion information of the regular hair strand and the initial pose of the regular hair strand.

In an embodiment of the present disclosure, after simulating the guide hair strand based on the hair strand data to obtain the simulated pose of the guide hair strand, the simulation module 32 is further configured to: obtain constraint information of the guide hair strand, where the constraint information is used to limit a hair strand length and/or a hair strand shape of the guide hair strand, and/or a distance between at least two guide hair strands; and correct the simulated pose based on the constraint information to obtain a corrected simulated pose. The processing module 33 is specifically configured to: obtain the motion information of the guide hair strand based on the corrected simulated pose and the initial pose of the guide hair strand.

The obtaining module 31, the simulation module 32, the processing module 33, and the rendering module 34 are connected in sequence. The hair strand processing apparatus 3 provided in this embodiment may perform the technical solution of the above method embodiment. The implementation principles and technical effects thereof are similar, which are not repeated in this embodiment.

FIG. 16 is a schematic diagram of a structure of an electronic device according to an embodiment of the present disclosure. As shown in FIG. 16, the electronic device 4 includes:
a processor 41, and a memory 42 in communication connection with the processor 41, where
the memory 42 stores computer-executable instructions; and
the processor 41 executes the computer-executable instructions stored in the memory 42 to implement the hair strand processing method according to the embodiments as shown in FIG. 2 to FIG. 14.

Optionally, the processor 41 and the memory 42 are connected through a bus 43.

The related description may be understood with reference to related description and effects that correspond to the steps in the embodiments corresponding to FIG. 2 to FIG. 14. Details are not described herein again.

An embodiment of the present disclosure provides a computer-readable storage medium. The computer-readable storage medium stores computer-executable instructions, and the computer-executable instructions, when executed by a processor, are used to implement the hair strand processing method according to any one of the embodiments corresponding to FIG. 2 to FIG. 14 of the present disclosure.

An embodiment of the present disclosure provides a computer program product, including a computer program that, when executed by a processor, causes the hair strand processing method according to the embodiments shown in FIG. 2 to FIG. 14 to be implemented.

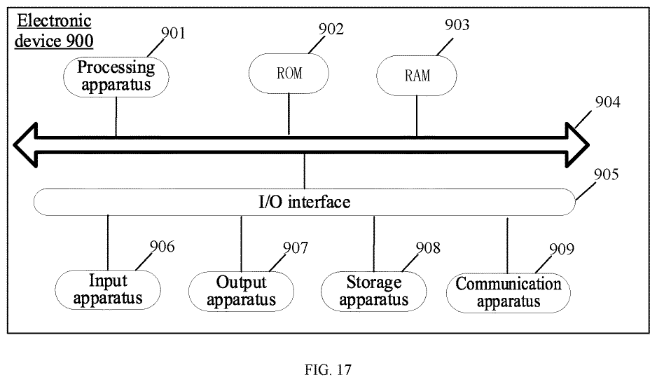

FIG. 17 is a schematic diagram of a structure of an electronic device 900 suitable for implementing the embodiments of the present disclosure. The electronic device 900 may be a terminal device or a server. The terminal device may include, but is not limited to, a mobile terminal such as a mobile phone, a notebook computer, a digital broadcast receiver, a personal digital assistant (PDA), a tablet computer (portable Android device, PAD), a portable media player (PMP), and a vehicle-mounted terminal (such as a vehicle navigation terminal), and a fixed terminal such as a digital TV and a desktop computer. The electronic device shown in FIG. 17 is merely an example, and shall not impose any limitation on the function and scope of use of the embodiments of the present disclosure.

As shown in FIG. 17, the electronic device 900 may include a processing apparatus (for example, a central processing unit and a graphics processing unit) 901, which may perform various appropriate actions and processing according to programs stored in a read-only memory (ROM) 902 or loaded from a storage apparatus 908 into a random access memory (RAM) 903. The RAM 903 further stores various programs and data required for the operation of the electronic device 900. The processing apparatus 901, the ROM 902, and the RAM 903 are connected to one another through a bus 904. An input/output (I/O) interface 905 is also connected to the bus 904.

Generally, the following apparatuses may be connected to the I/O interface 905: an input apparatus 906 including, for example, a touchscreen, a touchpad, a keyboard, a mouse, a camera, a microphone, an accelerometer, and a gyroscope; an output apparatus 907 including, for example, a liquid crystal display (LCD), a speaker, and a vibrator; the storage apparatus 908 including, for example, a tape and a hard disk; and a communication apparatus 909. The communication apparatus 909 may allow the electronic device 900 to perform wireless or wired communication with other devices to exchange data. Although FIG. 17 shows the electronic device 900 having various apparatuses, it should be understood that it is not required to implement or have all of the shown apparatuses. It may be an alternative to implement or have more or fewer apparatuses.

In particular, according to an embodiment of the present disclosure, the process described above with reference to the flowchart may be implemented as a computer software program. For example, this embodiment of the present disclosure includes a computer program product, which includes a computer program carried on a computer-readable medium, where the computer program includes program code for performing the method shown in the flowchart. In such an embodiment, the computer program may be downloaded and installed from a network through the communication apparatus 909, installed from the storage apparatus 908, or installed from the ROM 902. When the computer program is executed by the processing apparatus 901, the above functions defined in the method of the embodiment of the present disclosure are performed.

It should be noted that the above computer-readable medium described in the present disclosure may be a computer-readable signal medium, a computer-readable storage medium, or any combination thereof. The computer-readable storage medium may be, for example but not limited to, electric, magnetic, optical, electromagnetic, infrared, or semiconductor systems, apparatuses, or devices, or any combination thereof. More specific examples of the computer-readable storage medium may include, but are not limited to: an electrical connection having one or more wires, a portable computer magnetic disk, a hard disk, a random access memory (RAM), a read-only memory (ROM), an erasable programmable read-only memory (EPROM) (or a flash memory), an optical fiber, a portable compact disc read-only memory (CD-ROM), an optical storage device, a magnetic storage device, or any suitable combination thereof. In the present disclosure, the computer-readable storage medium may be any tangible medium containing or storing a program which may be used by or in combination with an instruction execution system, apparatus, or device. In the present disclosure, the computer-readable signal medium may include a data signal propagated in a baseband or as a part of a carrier, and the data signal carries computer-readable program code. The propagated data signal may be in various forms, including but not limited to an electromagnetic signal, an optical signal, or any suitable combination thereof. The computer-readable signal medium may further be any computer-readable medium other than the computer-readable storage medium. The computer-readable signal medium can send, propagate, or transmit a program used by or in combination with an instruction execution system, apparatus, or device. The program code contained in the computer-readable medium may be transmitted by any suitable medium, including but not limited to: electric wires, optical cables, radio frequency (RF), and the like, or any suitable combination thereof.

The above computer-readable medium may be contained in the above electronic device. Alternatively, the computer-readable medium may exist independently, without being assembled into the electronic device.

The above computer-readable medium carries one or more programs that, when executed by the electronic device, cause the electronic device to perform the method shown in the above embodiment.

The computer program code for performing the operations in the present disclosure may be written in one or more programming languages or a combination thereof, where the programming languages include an object-oriented programming language, such as Java, Smalltalk, or C++, and further include conventional procedural programming languages, such as “C” language or similar programming languages. The program code may be completely executed on a computer of a user, partially executed on a computer of a user, executed as an independent software package, partially executed on a computer of a user and partially executed on a remote computer, or completely executed on a remote computer or server. In the case of involving the remote computer, the remote computer may be connected to the user computer through any kind of network, including a local area network (LAN) or a wide area network (WAN), or may be connected to an external computer (e.g., utilizing an Internet service provider for Internet connectivity).

The flowchart and block diagram in the accompanying drawings illustrate the possibly implemented architecture, functions, and operations of the system, method, and computer program product according to various embodiments of the present disclosure. In this regard, each block in the flowchart or block diagram may represent a module, program segment, or part of code, and the module, program segment, or part of code contains one or more executable instructions for implementing the specified logical functions. It should also be noted that, in some alternative implementations, the functions marked in the blocks may also occur in an order different from that marked in the accompanying drawings. For example, two blocks shown in succession can actually be performed substantially in parallel, or they can sometimes be performed in the reverse order, depending on the functions involved. It should also be noted that each block in the block diagram and/or the flowchart, and a combination of the blocks in the block diagram and/or the flowchart may be implemented by a dedicated hardware-based system that executes specified functions or operations, or may be implemented by a combination of dedicated hardware and computer instructions.

The related units described in the embodiments of the present disclosure may be implemented by software, or may be implemented by hardware. Names of the units do not constitute a limitation on the units themselves in some cases, for example, a first obtaining unit may alternatively be described as “a unit for obtaining at least two internet protocol addresses”.

The functions described herein above may be performed at least partially by one or more hardware logic components. For example, without limitation, exemplary types of hardware logic components that may be used include: a field programmable gate array (FPGA), an application-specific integrated circuit (ASIC), an application-specific standard product (ASSP), a system-on-chip (SOC), a complex programmable logic device (CPLD), and the like.

In the context of the present disclosure, a machine-readable medium may be a tangible medium that may contain or store a program used by or in combination with an instruction execution system, apparatus, or device. The machine-readable medium may be a machine-readable signal medium or a machine-readable storage medium. The machine-readable medium may include, but is not limited to, an electronic, magnetic, optical, electromagnetic, infrared, or semiconductor system, apparatus, or device, or any suitable combination thereof. More specific examples of the machine-readable storage medium may include an electrical connection based on one or more wires, a portable computer disk, a hard disk, a random access memory (RAM), a read-only memory (ROM), an erasable programmable read-only memory (EPROM) (or a flash memory), an optic fiber, a portable compact disc read-only memory (CD-ROM), an optical storage device, a magnetic storage device, or any suitable combination thereof.

The foregoing descriptions are merely preferred embodiments of the present disclosure and explanations of the applied technical principles. Those skilled in the art should understand that the scope of disclosure involved in the present disclosure is not limited to the technical solutions formed by specific combinations of the foregoing technical features, and shall also cover other technical solutions formed by any combination of the foregoing technical features or equivalent features thereof without departing from the foregoing concept of disclosure. For example, a technical solution formed by a replacement of the foregoing features with technical features with similar functions disclosed in the present disclosure (but not limited thereto) also falls within the scope of the present disclosure.

In addition, although the various operations are depicted in a specific order, it should not be construed as requiring these operations to be performed in the specific order shown or in a sequential order. Under particular circumstances, multitasking and parallel processing may be advantageous. Similarly, although several specific implementation details are included in the foregoing discussions, these details should not be construed as limiting the scope of the present disclosure. Some features that are described in the context of separate embodiments can also be implemented in combination in a single embodiment. In contrast, various features described in the context of a single embodiment may alternatively be implemented in a plurality of embodiments individually or in any suitable subcombination.

Although the subject matter has been described in a language specific to structural features and/or logical actions of the method, it should be understood that the subject matter defined in the appended claims is not necessarily limited to the specific features or actions described above. In contrast, the specific features and actions described above are merely exemplary forms of implementing the claims.

1. A hair strand processing method, comprising:
obtaining hair strand data, and classifying the hair strand data into a guide hair strand and a regular hair strand;
processing the guide hair strand based on an initial pose of the guide hair strand to obtain a simulated pose of the guide hair strand;
obtaining motion information of the guide hair strand based on the simulated pose and the initial pose of the guide hair strand, wherein the motion information represents a posture change feature of the simulated pose of the guide hair strand relative to the initial pose of the guide hair strand; and
obtaining a rendered hair strand image based on the motion information and an initial pose of the regular hair strand.

2. The method according to claim 1, wherein the processing the guide hair strand based on an initial pose of the guide hair strand to obtain a simulated pose of the guide hair strand comprises:
obtaining a particle motion state of a hair strand particle of the guide hair strand, wherein the particle motion state represents at least one of a motion velocity and/or motion acceleration of the hair strand particle;
obtaining simulated coordinates based on initial coordinates of the hair strand particle and a corresponding particle motion state; and
obtaining the simulated pose of the guide hair strand based on simulated coordinates of at least two hair strand particles of the guide hair strand.

3. The method according to claim 2, wherein the particle motion state comprises a first motion velocity of the hair strand particle, and the obtaining simulated coordinates based on initial coordinates of the hair strand particle and a corresponding particle motion state comprises:
obtaining a first decay velocity corresponding to the hair strand particle based on the first motion velocity of the hair strand particle;
correcting the particle motion state of the hair strand particle based on the first decay velocity to obtain a first corrected motion state; and
obtaining the simulated coordinates based on the initial coordinates of the hair strand particle and the corresponding first corrected motion state.

4. The method according to claim 2, wherein the at least two hair strand particles of the guide hair strand comprise a hair-tip particle, and the obtaining simulated coordinates based on initial coordinates of the hair strand particle and a corresponding particle motion state comprises:
setting a virtual hair strand particle of the guide hair strand, wherein the virtual hair strand particle is located in an extension direction on a side of the hair-tip particle of the guide hair strand;
obtaining a second decay velocity corresponding to the hair-tip particle based on a position constraint relationship between the virtual hair strand particle and the hair-tip particle, wherein a direction of the second decay velocity is an opposite direction to a direction of a connecting line from the hair-tip particle to adjacent hair strand particles of the hair-tip particle;
correcting the particle motion state of the hair strand particle based on the second decay velocity to obtain a second corrected motion state; and
obtaining the simulated coordinates based on the initial coordinates of the hair strand particle and the corresponding second corrected motion state.

5. The method according to claim 1, wherein the obtaining a rendered hair strand image based on the motion information and an initial pose of the regular hair strand comprises:
processing the initial pose of the regular hair strand based on the motion information to obtain a simulated pose of the regular hair strand; and
performing image rendering based on the simulated pose of the regular hair strand to obtain the rendered hair strand image.

6. The method according to claim 5, wherein
the simulating the initial pose of the regular hair strand based on the motion information to obtain a simulated pose of the regular hair strand comprises:
obtaining, based on a correspondence between the guide hair strand and the regular hair strand, a hair strand particle of the regular hair strand that corresponds to the hair strand particle of the guide hair strand;
obtaining, based on the motion information, a coordinate change amount corresponding to the hair strand particle of the regular hair strand;
obtaining, based on the coordinate change amount of the hair strand particle of the regular hair strand and initial coordinates of the hair strand particle of the regular hair strand, simulated coordinates corresponding to the hair strand particle of the regular hair strand; and
obtaining the simulated pose of the regular hair strand based on simulated coordinates of hair strand particles of the at least two regular hair strands.

7. The method according to claim 1, wherein the initial pose of the guide hair strand comprises initial coordinates of the at least two hair strand particles corresponding to the guide hair strand; and the simulated pose comprises the simulated coordinates of the at least two hair strand particles corresponding to the guide hair strand; and
the obtaining motion information of the guide hair strand based on the simulated pose and the initial pose of the guide hair strand comprises:
obtaining a coordinate transformation amount of the hair strand particle based on the initial coordinates of the hair strand particle and the corresponding simulated coordinates; and
obtaining the motion information of the guide hair strand based on coordinate change amounts of the at least two hair strand particles.

8. The method according to claim 1, further comprising:
obtaining guide data corresponding to the hair strand data, wherein the guide data is configured to represent a mapping relationship and a mapping weight between the guide hair strand and the corresponding regular hair strand; and
the obtaining a rendered hair strand image based on the motion information and an initial pose of the regular hair strand comprises:
obtaining weighted motion information corresponding to each regular hair strand based on the guide data; and
obtaining the rendered hair strand image based on the weighted motion information of the regular hair strand and the initial pose of the regular hair strand.

9. The method according to claim 1, wherein after processing the guide hair strand based on the hair strand data to obtain the simulated pose of the guide hair strand, the method further comprises:
obtaining constraint information of the guide hair strand, wherein the constraint information is configured to limit at least one of: (1) at least one of a hair strand length or a hair strand shape of the guide hair strand, or (2) a distance between at least two guide hair strands; and
correcting the simulated pose based on the constraint information to obtain a corrected simulated pose; and
the obtaining motion information of the guide hair strand based on the simulated pose and the initial pose of the guide hair strand comprises:
obtaining the motion information of the guide hair strand based on the corrected simulated pose of the guide hair strand and the initial pose of the guide hair strand.

10. (canceled)

11. An electronic device, comprising: a processor and a memory communicatively connected to the processor, wherein
the memory stores computer-executable instructions; and
the processor executes the computer-executable instructions stored in the memory to implement a hair strand processing method, comprising:
obtaining hair strand data, and classifying the hair strand data into a guide hair strand and a regular hair strand;
processing the guide hair strand based on an initial pose of the guide hair strand to obtain a simulated pose of the guide hair strand:
obtaining motion information of the guide hair strand based on the simulated pose and the initial pose of the guide hair strand, wherein the motion information represents a posture change feature of the simulated pose of the guide hair strand relative to the initial pose of the guide hair strand; and
obtaining a rendered hair strand image based on the motion information and an initial pose of the regular hair strand.

12. A non-transitory computer-readable storage medium, storing computer-executable instructions that, when executed by a processor, cause a hair strand processing method to be implemented, the method comprising:
obtaining hair strand data, and classifying the hair strand data into a guide hair strand and a regular hair strand;
processing the guide hair strand based on an initial pose of the guide hair strand to obtain a simulated pose of the guide hair strand;
obtaining motion information of the guide hair strand based on the simulated pose and the initial pose of the guide hair strand, wherein the motion information represents a posture change feature of the simulated pose of the guide hair strand relative to the initial pose of the guide hair strand; and
obtaining a rendered hair strand image based on the motion information and an initial pose of the regular hair strand.

13. (canceled)

14. (canceled)

15. The electronic device according to claim 11, wherein the processing the guide hair strand based on an initial pose of the guide hair strand to obtain a simulated pose of the guide hair strand comprises:
obtaining a particle motion state of a hair strand particle of the guide hair strand, wherein the particle motion state represents at least one of a motion velocity or motion acceleration of the hair strand particle;
obtaining simulated coordinates based on initial coordinates of the hair strand particle and a corresponding particle motion state; and
obtaining the simulated pose of the guide hair strand based on simulated coordinates of at least two hair strand particles of the guide hair strand.

16. The electronic device according to claim 15, wherein the particle motion state comprises a first motion velocity of the hair strand particle, and the obtaining simulated coordinates based on initial coordinates of the hair strand particle and a corresponding particle motion state comprises:
obtaining a first decay velocity corresponding to the hair strand particle based on the first motion velocity of the hair strand particle;
correcting the particle motion state of the hair strand particle based on the first decay velocity to obtain a first corrected motion state; and
obtaining the simulated coordinates based on the initial coordinates of the hair strand particle and the corresponding first corrected motion state.

17. The electronic device according to claim 15, wherein the at least two hair strand particles of the guide hair strand comprise a hair-tip particle, and the obtaining simulated coordinates based on initial coordinates of the hair strand particle and a corresponding particle motion state comprises:
setting a virtual hair strand particle of the guide hair strand, wherein the virtual hair strand particle is located in an extension direction on a side of the hair-tip particle of the guide hair strand;
obtaining a second decay velocity corresponding to the hair-tip particle based on a position constraint relationship between the virtual hair strand particle and the hair-tip particle, wherein a direction of the second decay velocity is an opposite direction to a direction of a connecting line from the hair-tip particle to adjacent hair strand particles of the hair-tip particle;
correcting the particle motion state of the hair strand particle based on the second decay velocity to obtain a second corrected motion state; and
obtaining the simulated coordinates based on the initial coordinates of the hair strand particle and the corresponding second corrected motion state.

18. The electronic device according to claim 11, wherein the obtaining a rendered hair strand image based on the motion information and an initial pose of the regular hair strand comprises:
processing the initial pose of the regular hair strand based on the motion information to obtain a simulated pose of the regular hair strand; and
performing image rendering based on the simulated pose of the regular hair strand to obtain the rendered hair strand image.

19. The electronic device according to claim 18, wherein
the simulating the initial pose of the regular hair strand based on the motion information to obtain a simulated pose of the regular hair strand comprises:
obtaining, based on a correspondence between the guide hair strand and the regular hair strand, a hair strand particle of the regular hair strand that corresponds to the hair strand particle of the guide hair strand;
obtaining, based on the motion information, a coordinate change amount corresponding to the hair strand particle of the regular hair strand;
obtaining, based on the coordinate change amount of the hair strand particle of the regular hair strand and initial coordinates of the hair strand particle of the regular hair strand, simulated coordinates corresponding to the hair strand particle of the regular hair strand; and
obtaining the simulated pose of the regular hair strand based on simulated coordinates of hair strand particles of the at least two regular hair strands.

20. The non-transitory computer-readable storage medium according to claim 12, wherein the processing the guide hair strand based on an initial pose of the guide hair strand to obtain a simulated pose of the guide hair strand comprises:
obtaining a particle motion state of a hair strand particle of the guide hair strand, wherein the particle motion state represents at least one of a motion velocity or motion acceleration of the hair strand particle;
obtaining simulated coordinates based on initial coordinates of the hair strand particle and a corresponding particle motion state; and
obtaining the simulated pose of the guide hair strand based on simulated coordinates of at least two hair strand particles of the guide hair strand.

21. The non-transitory computer-readable storage medium according to claim 20, wherein the particle motion state comprises a first motion velocity of the hair strand particle, and the obtaining simulated coordinates based on initial coordinates of the hair strand particle and a corresponding particle motion state comprises:
obtaining a first decay velocity corresponding to the hair strand particle based on the first motion velocity of the hair strand particle;
correcting the particle motion state of the hair strand particle based on the first decay velocity to obtain a first corrected motion state; and
obtaining the simulated coordinates based on the initial coordinates of the hair strand particle and the corresponding first corrected motion state.

22. The non-transitory computer-readable storage medium according to claim 21, wherein the at least two hair strand particles of the guide hair strand comprise a hair-tip particle, and the obtaining simulated coordinates based on initial coordinates of the hair strand particle and a corresponding particle motion state comprises:
setting a virtual hair strand particle of the guide hair strand, wherein the virtual hair strand particle is located in an extension direction on a side of the hair-tip particle of the guide hair strand;
obtaining a second decay velocity corresponding to the hair-tip particle based on a position constraint relationship between the virtual hair strand particle and the hair-tip particle, wherein a direction of the second decay velocity is an opposite direction to a direction of a connecting line from the hair-tip particle to adjacent hair strand particles of the hair-tip particle;
correcting the particle motion state of the hair strand particle based on the second decay velocity to obtain a second corrected motion state; and
obtaining the simulated coordinates based on the initial coordinates of the hair strand particle and the corresponding second corrected motion state.

23. The non-transitory computer-readable storage medium according to claim 12, wherein the obtaining a rendered hair strand image based on the motion information and an initial pose of the regular hair strand comprises:
processing the initial pose of the regular hair strand based on the motion information to obtain a simulated pose of the regular hair strand; and
performing image rendering based on the simulated pose of the regular hair strand to obtain the rendered hair strand image.
